(19) United States
(12) Patent Application Publication
(10) Pub. No.: US 2026/0024469 A1
(43) Pub. Date: Jan. 22, 2026

(54) Stabilizer Foot for Deployable Portable Sign System

(71) Applicant: Information Exchange Network, Inc., El Reno, OK (US)

(72) Inventors: Russell Edward Latenser, II, Edmond, OK (US); Thomas Scott Johnson, Oklahoma City, OK (US); Frederick Daniel Garrett, El Reno, OK (US)

(73) Assignee: Information Exchange Network, Inc., El Reno, OK (US)

(21) Appl. No.: 18/779,635

(22) Filed: Jul. 22, 2024

(51) Int. Cl. G09F 7/18; G09F 21/04

(52) U.S. Cl. CPC G09F 7/18; G09F 21/04; G09F 2007/1856

(57) ABSTRACT

An improved foot for a stabilizer for a separable and deployable portable sign having a foot plate; one or more brackets attachable to an end of a vertical extension member of a jack or stabilizer; a pivoting attachment between the foot plate and the one or more brackets; and an optionally-removeable friction plate affixed to a bottom of the foot plate, wherein the friction plate is provided with a friction component having a coefficient of friction greater than a coefficient of friction of steel on concrete and greater than a coefficient of friction of steel on asphalt, wherein the friction component resists lateral movement of the foot plate relative to a surface on which the foot plate rests.

### INCORPORATION BY REFERENCE

U.S. patent application Ser. No. 18/466,427, Applicant's Agent's docket FGP23REL1, filed on Sep. 13, 2023, by Russell Edward Latenser II et al. which discloses a related invention, is hereby incorporated by reference in its entirety, including figures.

### FIELD OF THE INVENTION

The present invention relates to feet and base plates for stabilizers for portable sign systems such as but not limited to roadside informational signs.

### BACKGROUND OF THE INVENTION

Portable signs are often used for temporary situations in which regional information is to be disseminated for a limited period of time. One such situation is during road construction, portable signs may be deployed adjacent to lanes of traffic prior to and throughout the construction zone. Many of these signs may or may not be digital in nature. Digital signs can convey messages, directions, warnings, and information to drivers that is dynamically changeable and updateable both locally (using a controller) and remotely (over a wireless connection). Some portable signs also provide a fixed message. Digital signs can include LED and flip-disc signs, and in some products, a scrolling banner.

Other portable signs may be intended by other types of viewers, such as foot travelers at an event such as a fair, carnival, concert, sports event, etc., and runners, such as at a marathon or triathlon.

### SUMMARY OF THE INVENTION

Disclosed herein is an improved foot for a stabilizer for a separable and deployable portable sign having a foot plate; one or more brackets attachable to an end of a vertical extension member of a jack or stabilizer; a pivoting attachment between the foot plate and the one or more brackets; and an optionally-removeable friction plate affixed to a bottom of the foot plate, wherein the friction plate is provided with a friction component having a coefficient of friction greater than a coefficient of friction of steel on concrete and greater than a coefficient of friction of steel on asphalt, wherein the friction component resists lateral movement of the foot plate relative to a surface on which the foot plate rests.

### BRIEF DESCRIPTION OF DRAWINGS

The figures presented herein, when considered in light of this description, form a complete disclosure of one or more embodiments of the invention, wherein like reference numbers in the figures represent similar or same elements or steps.

FIG. 1 depicts an embodiment according to the related invention of a deployable sign system having a trailer and a separable sign subsystem.

FIG. 2 illustrates an embodiment according to the related invention of a separable sign system as deployed.

FIG. 3 illustrates an embodiment according to the related invention of a trailer for transporting, deploying, and collecting a separable sign system.

FIG. 4 sets forth an embodiment according to the related invention of deploying and retrieving (or collecting) a separable sign system.

FIG. 5 shows a top-down view of the embodiment according to the related invention of FIG. 1.

FIG. 6 illustrates operation of several components of the embodiment according to the related invention of FIG. 5.

FIG. 7 shows a comparison of the footprint improvements versus the usual (unimproved) footprint of a deployed portable sign.

FIG. 8 depicts deployment of a separable sign system on uneven ground or surfaces.

FIG. 9 shows more details of an example embodiment of an improved stabilizer foot according to the present invention.

FIG. 10 illustrates a side view of an example embodiment of an improved stabilizer foot according to the present invention.

FIG. 11 depicts a rotated view of FIG. 10.

FIG. 12 shows the pivoting action of the example embodiments of FIGS. 10 and 11.

FIG. 13 illustrates conformance of the example embodiments of FIGS. 10 and 11 to a non-level surface and engagement thereof.

FIG. 14 illustrates conformance of the example embodiments of FIGS. 10 and 11 to a level surface and engagement thereof.

FIG. 15 depicts the removal and installation of a variety of friction plates for engaging different types of surfaces, according to at least on example embodiment of the invention.

FIG. 16 shows another example embodiment of the invention which receives an earth anchor for increased lateral movement stability and resistance to lifting (tipping).

FIG. 17 shows a top-down view of an example embodiment of the invention which is configured with holes to receive earth anchors, pins, stakes, spikes or other anchoring devices.

FIG. 18 shows well-known jack feet and stabilizer pads available in the market.

### DETAILED DESCRIPTION

The present inventors have realized multiple unmet needs in the arts of portable sign systems. Portable sign systems, such as those often seen along roads during road construction are:
a. Highly vulnerable to damage from passing vehicles and construction equipment. The industry sustains an average of 1 in 6 signs destroyed by vehicle collisions per year. This damage primarily affects or destroys the trailer undercarriage (wheels, axles, lighting) in addition to the sign itself.
b. Regularly vandalized and highly susceptible to theft. Trailer lights, trailer wheels, batteries, wiring, and even trailer axles are stolen.
c. Tipped over by wind gusts. Most current sign structures attached to and dependent on trailers are only half as wide as they are long. Typical trailer construction is 7 feet wide by 14 feet long. Many of the attached signs are typically 7 feet high by 11 feet wide. The signs themselves act are large sails in high winds or strong wind gusts. At many wind angles, the signs are easily tipped over on their sides. It is common with the existing sign trailers to see them tip over in winds as low as 45 mph.
d. Not designed to lower operational costs. The setup and takedown for a currently designed individual sign can easily exceed two hours.
   i. The stabilizers are currently located on the corners of the trailer. Most, if not all, are hand cranked, meaning it takes about 3 to 5 minutes per corner to deploy a stabilizer. The placement of these stabilizers is primarily used to level the signs and hold it up while the wheels are removed. Their location does not increase the sign footprint, meaning they minimally increase the sign stability in winds.
   ii. To prevent theft, the sign owners are forced to remove the wheels and even the axles, depending on the location.
   iii. In an ineffective attempt to keep the sign from tipping over, sandbags are used to weigh the sign down. The sandbags are transported in a truck, then manually placed all over the sign frame. This process takes up to 15 minutes to add the sandbags and another 15 minutes to remove the sandbags. Additionally, the typical sandbag weighs 40 pounds, introducing the strong possibility of back injuries.

The present inventors have realized that several fundamental improvements to the overall system design can address multiple problems in the present art. This elegant solution or sort of “one-solution-solves-several-problems” is especially efficient and innovative, but is counterintuitive to the approach taken by existing suppliers engaged in the business of manufacturing and selling such portable sign systems. The present inventors' system design is addressing the total life cycle costs of the system design as opposed to the current existing manufacturers' approaches of only minimizing the manufacturing costs while not addressing the operational and maintenance costs for the purchasing entity.

The Related Invention. In U.S. patent application Ser. No. 18/466,427, Applicant's Agent's docket FGP23REL1, filed on Sep. 13, 2023, by Russell Edward Latenser II, et al., the present applicants disclosed a related invention which is used in the present disclosure as at least one example environment or context in which the present invention may be utilized to benefit stability of deployed signs. Those ordinarily skilled in the art will realize that the present invention, an improved stabilizer foot, may be beneficial to other types of deployable devices and systems, such as other trailer designs, truck stabilizers (e.g., bucket trucks, ladder trucks, fire engines, cranes, etc.), and the like. As such, the following example manners of using the improved stabilizer foot are provided for illustration only, and do not represent the limits of the invention itself and the various available embodiments thereof.

In the related patent application, the present inventors noted that one characteristic of currently designed portable sign systems is that they are universally and permanently provided with their own means of transportation, e.g., wheels, axles, etc. This old design means that when a unit is damaged, such as in a collision with a vehicle, not only is the sign subsystem damaged, but so is the frame, axle, etc., of the transportation subsystem. The trailer portion of the sign generally represents 25% of the total cost of the unit. The permanently integrated trailer portion of the sign means a greater repair cost, higher insurance costs, and higher maintenance costs. Further, current portable sign systems also have permanently attached towing devices (e.g., trailer hitch couplers). Theft of the units is made easy—anyone with a suitable towing hitch may cut through a simple padlock to steal the entire unit or require the owner to purchase unique and expensive locking mechanisms to prevent their theft.

The present inventors realized and devised a related invention, example embodiments of which are disclosed in the following paragraphs, which reduces the:
a. Acquisition costs (by significantly reducing the trailer costs).
b. Repair costs.
c. Insurance costs.
d. Susceptibility to theft and vandalism.
e. Significant operational costs in terms man hours sign setup and takedown.
   i. No requirement to remove or replace wheels on site to move it.
   ii. No requirement to remove or replace axles on site.
   iii. No requirement to load and remove sandbags.
   iv. Drill operated stabilizers to reduce setup time.
f. Work related injuries.

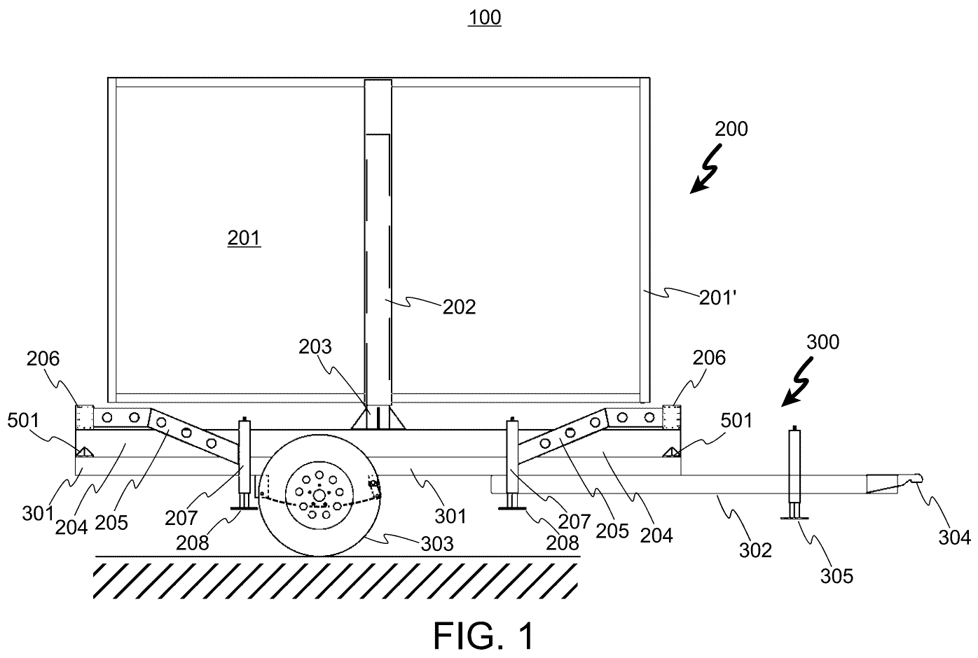

Referring now to FIG. 1, a side view 100 of an embodiment according to the related invention. This example embodiment will be illustrated with respect to an expensive LED or light-bulb electronic portable sign, but those ordinarily skilled in the relevant arts will realize that the invention may equally be realized to other forms of portable signs including, but not limited to, static (fixed) message signs. The portable sign system has two subsystems: a deployable and separable sign subsystem 200, and a transportation platform 300. Both subsystems may be completely custom designed and built to interoperate with each other, and in other embodiments, one or both of the subsystems may be realized using existing hardware with certain adapters to achieve the invention.

The separable sign subsystem 200 has a sign or display panel 201 supported by a riser 202 and a riser base 203 to a sign base 204. The sign panel 201 may be enclosed in a panel frame 201′ in some embodiments. The sign subsystem base 204 is provided with one or more lift-stabilizers 205, which of which has an earth-engaging foot 208, lift or level adjuster 207, and an attachment 206 to the sign subsystem 200 base 204.

The transportation subsystem 300 has two or more wheels 303 attached via an axle to a transportation frame 301 and may include a hitch coupler 304 and a jack stand 305 to hitch to a tow vehicle such as a truck. This particular embodiment example resembles a custom or adapted trailer, and in other embodiments, it may resemble an intermodal trailer, a custom or adapted dolly, cart, etc.

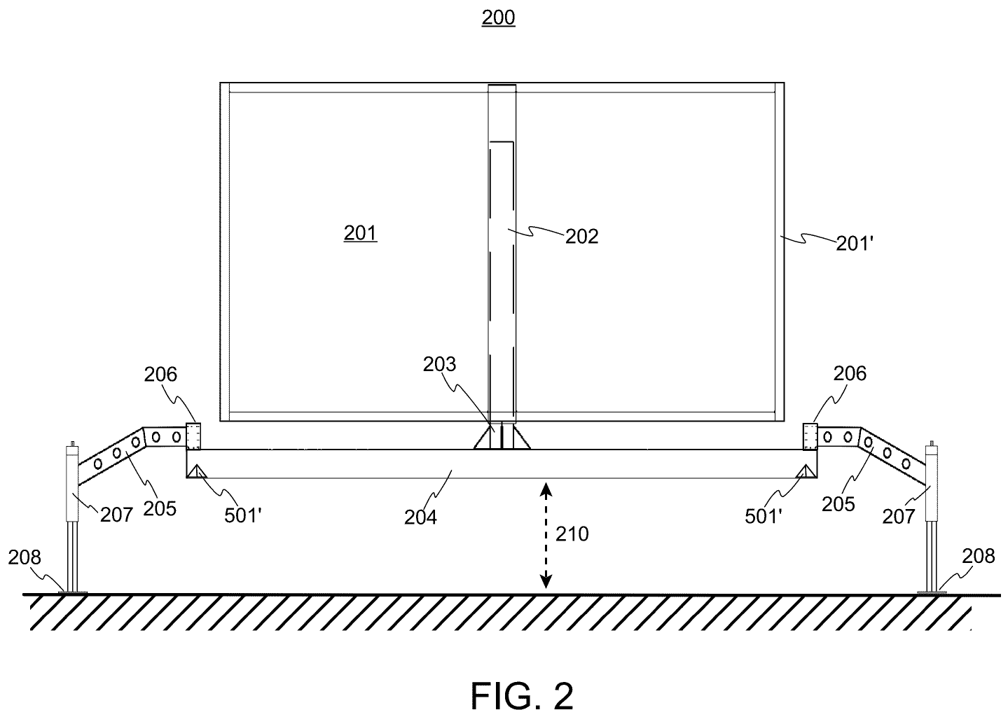

Referring now to FIG. 2, an embodiment according to the related invention of a separable and deployable sign subsystem 200 is shown in a configuration separated and deployed from a transportation subsystem. This is a side view, such as that in FIG. 1, with the lift-stabilizers 205 rotated from their stowed position to their operational position, and with the feet 208 to the lift-stabilizers extended (lowered) to engage the ground and hold the sign subsystem above the transportation subsystem's height 210.

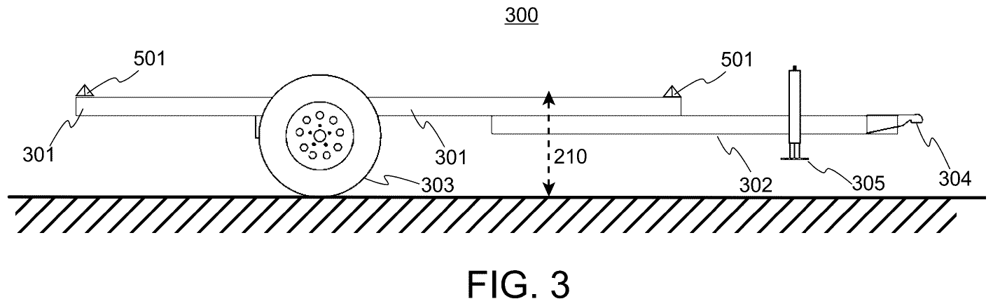

FIG. 3 shows an embodiment 300 according to the related invention of a transportation subsystem, such as that illustrated in FIG. 1, separated from a sign subsystem, ready to deploy or retrieve a sign subsystem. The mating clearance 210 allows the transportation portions of the overall system, namely the towing yoke 302, frame 301, coupler 304, axle, wheels 303, and associated vehicle lighting and registration plates to be removed from the site where the portable sign is deployed and used for a period of time. During this period of time, if the deployed and separated sign subsystem is subject to a collision, theft or vandalism, the cost of the transportation subsystem components is not involved and thereby saved. Further, by removing the primary means of transporting the sign subsystem, theft is significantly deterred.

These combined features and their benefits reduce the cost of manufacturing, purchasing, leasing, and operating a fleet of portable signs. For example, a sign fleet of 250 units now only requires 8 to 20 transportation subsystems for the 250 sign subsystems. Whereas the separable sign subsystems are expected to be less expensive individually than fully portable signs with permanently attached transportation means, this reduces fleet acquisition and operation costs significantly, including ancillary costs such as insurance.

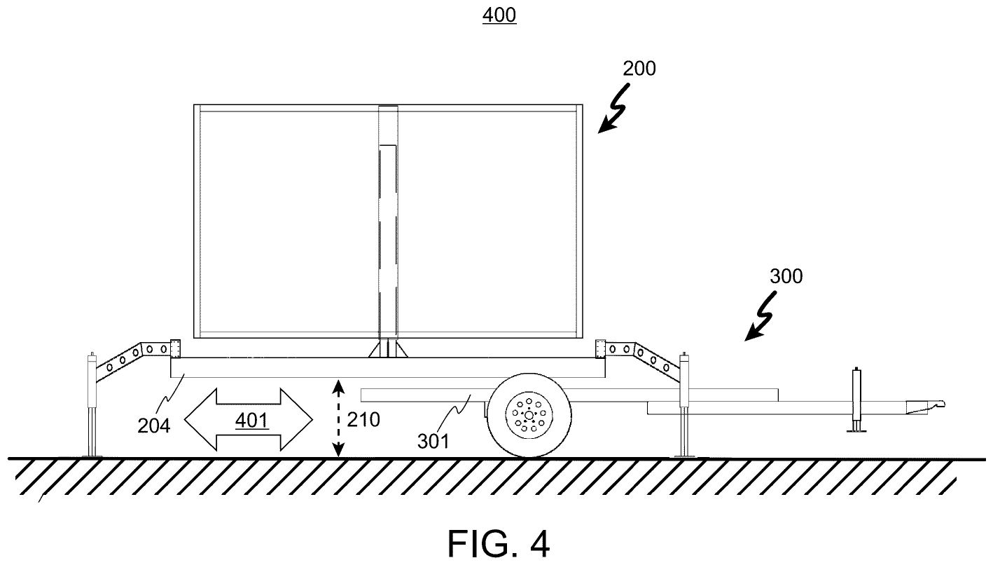

FIG. 4 depicts 400 an embodiment according to the related invention of deploying or retrieving a separable sign system 200 using a corresponding transportation subsystem 300. In this example, one can see that the mating clearance 210 which is defined by the minimum height to rise above the transportation subsystem to allow it to be rolled under or rolled away from 401 the deployed sigh subsystem 200 to leave a sigh system by a roadside, for example, or to retrieve it from a storage yard or at the end of usage at a construction zone, for example. The extendable or rotating lift-stabilizers of the invention increase the stance or distance between their points of contact with the ground to solve multiple issues:
a. Significantly increases the sign stability in winds by doubling the base footprint in order to prevent tip overs.
b. Effectively widens the narrow portion of the sign to almost be as wide as the sign structure is long, again preventing damage from wind tip overs.
c. Eliminate the need for a third-party lifting device for the sign itself by using the stabilizers themselves to raise and lower the sign onto the trailer sub assembly.
d. Accommodate the corresponding trailer, dolly, cart, etc., to be freely rolled underneath the sign subsystem without nearing the stabilizers.

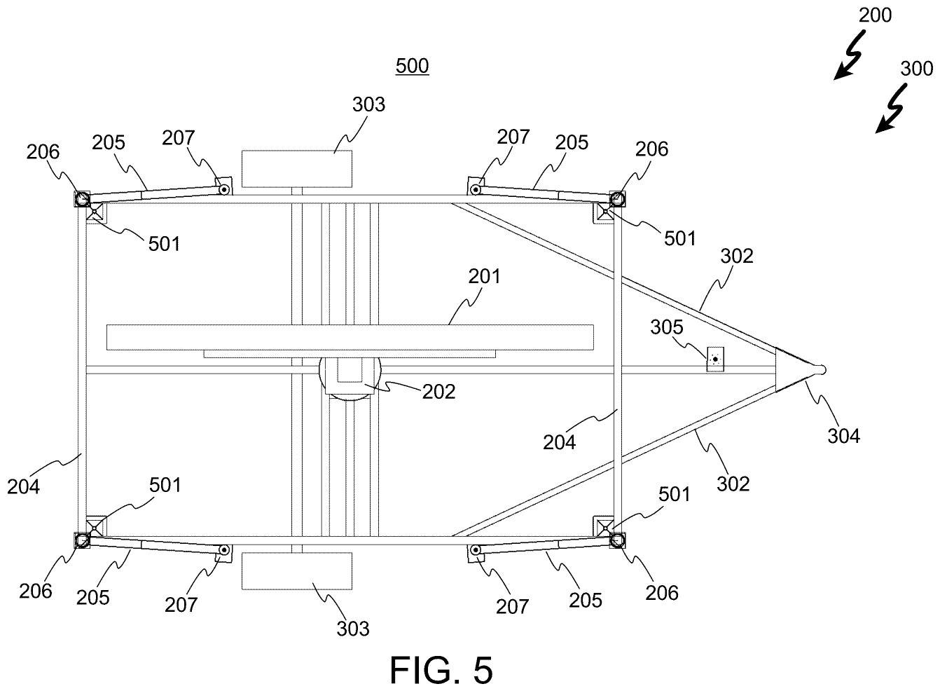

FIG. 5 shows 500 a top-down view of an embodiment according to the related invention in which four lift-stabilizers 205 can be seen pivotally attached to the base 204 of a sign subsystem 200. With the lift-stabilizers stowed in a position such as this, the combined transportation subsystem carrying the sign subsystem can be conveyed and navigated through ordinary traffic lanes or moving the sign to and from its point of use.

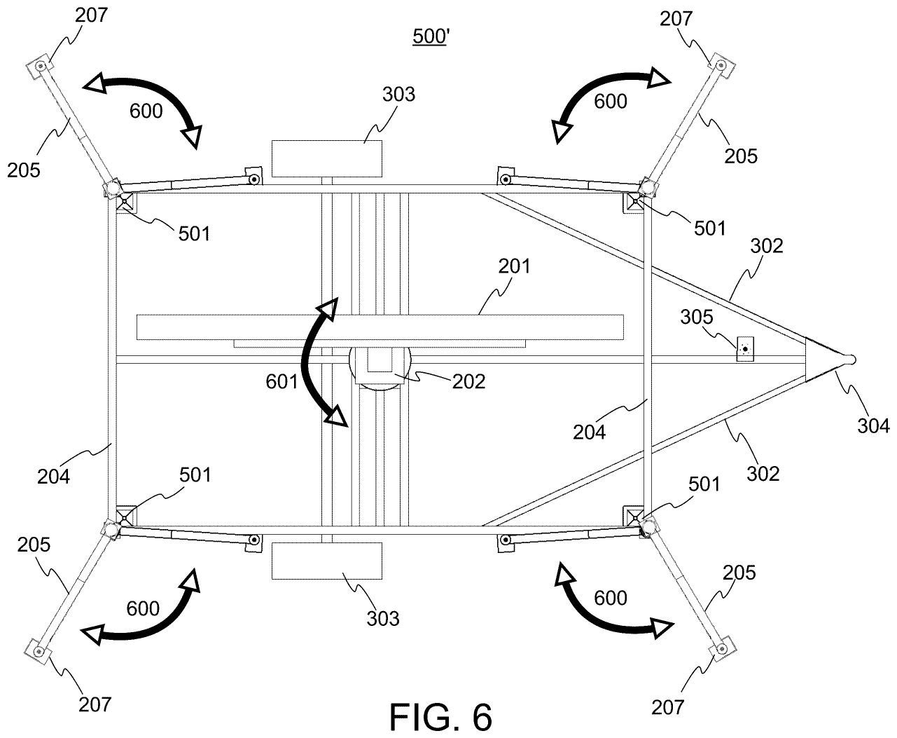

FIG. 6 illustrates 500′ the same example embodiment according to the related invention of FIG. 5 except the rotating action 600 of the lift-stabilizers and the optional rotating action 601 of the sign panel 201 are shown.

Please note that in at least one embodiment according to the related invention, one or more self-aligning devices are provided, such as pyramidal protrusions and matching recesses 501, 501′, are provided onto, into, with, in addition to, integral to, or a combination thereof, to the sign subsystem and the transportation subsystem. In this manner, custom transportation subsystems and “off the shelf” transportation subsystems may be adapted to carry, transport, deploy and retrieve the corresponding sign subsystem.

Embodiments of the Lift-Stabilizers. Options for embodiments according to the related invention for the lift-stabilizers include feet and/or height adjusters which can be lowered and raised by hand cranks and/or by power tools such as a cordless drill. The lift-stabilizers may be provided with surface-engaging feet or platforms, and in some embodiments, they may be provided with and earth anchor (e.g., ground screw or auger), such as those manufactured and sold by Sunmodo Corporation of Vancouver, Washington, USA. The earth anchor prevents the structure from being turned by the wind and then tipped over.

Besides the horizontally-swinging lift-stabilizers illustrated in the figures, still other options for the lift-stabilizers are units which rotate upwards for stowing, and units which include telescoping elements such as hollow square metal tubes that extend. Combinations of swinging horizontally, swinging vertically and/or extending telescopically are possible in some embodiments.

In at least one embodiment, the rotating or swingable lift-stabilizers will be approximately 3 feet long. Generally, a sign trailer is 7 feet wide and 14 feet long. With the 3-foot-long lift-stabilizers pivoted to a position 135° from across the width of the transportation subsystem (IE., 135° from along the length of the trailer), 2.1 feet of “footprint” is added in both length and width of the trailer for greatly increased stability against tipping over from wind. Such a configuration effectively increases the footprint of the deployed sign to 18.2 feet long by 11.2 feet wide, which is a 30% increase in length and 60% increase in width as compared to the trailer alone.

If the same example 3-foot long lift-stabilizers are rotated to 90° from along the length of the trailer (IE., parallel to the width of the trailer), then a full 3 feet of width to the footprint is added to the footprint of the deployed sign subsystem, with no addition to the length of the sign subsystem, resulting in a footprint that is 14 feet long (no change) by 13 feet wide, an 87% increase in footprint width.

With this example embodiment, the footprint of the deployed sign subsystem is essentially doubled compared to the footprint of a suitable trailer alone, which improves stability of the sign significantly. With the example 7′ by 14′ transportation subsystem, having a footprint of 98 square feet, and 3′ lift-stabilizers deployed at the 135° position, the deployed sign subsystem has a footprint of 11.2′ by 18.2′ for a total of 204 square feet, a 208% increase over the footprint of the transportation subsystem alone.

In an example embodiment of telescoping lift-stabilizers for a 7 foot wide sign structure, about 3 feet of square piping could be used for the extendable portion of the lift-stabilizer, such as square piping sliding inside of slightly larger square piping sleeve. Maintaining a foot of piping within the outer tube or sleeve for overlap and structural strength, a 90° positioned extension would add about 2 to the width of the footprint. This is also a significant improvement in stability, of course, but not as great of improvement as the longer swinging lift-stabilizer embodiment.

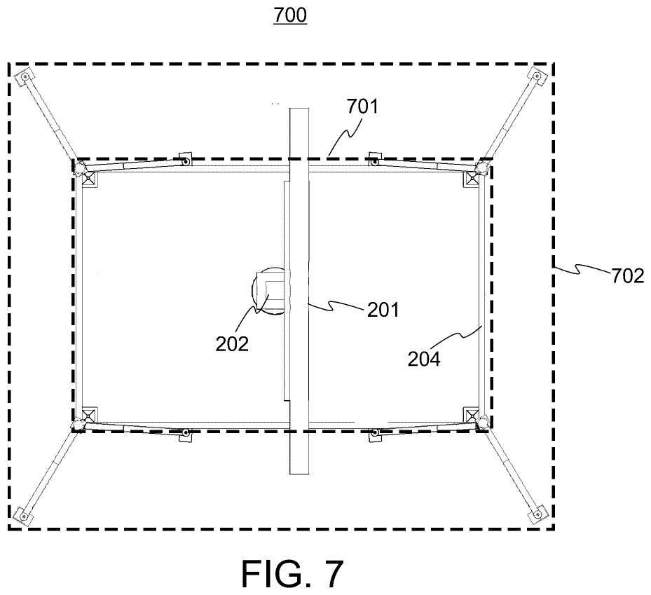

FIG. 7 illustrates 700 the improved footprint area 702 according to the related invention versus the normal trailer-only footprint area 701 of a currently available sign system (note the sign panel 201 is shown rotated in the normal position so that it can be viewed by oncoming traffic when the unit is parked alongside a roadway).

Sign Subsystem Embodiments of the Related Invention. Options for embodiments according to the related invention for the sign subsystem include using a thick metal plate for the sign panel frame and/or riser that is sized to accommodate batteries, wiring harnesses, and other valuable components that are subject to theft. In this manner, the structure of the sign subsystem becomes a type of anti-theft locker or safe for the most valuable components.

Options for embodiments according to the related invention for the powering of active signs, such as LED or flip-disk signs, include solar panels, wind generators, batteries, chargers, and fossil fuel generators. Static, fixed-message signs may also benefit from active lighting to avoid reliance solely on reflectance for observability of the sign during low and no light conditions.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

Improved Stabilizer Foot. Turning now to the present invention, the example deployable sign discussed in the foregoing paragraphs is further improved against wind-caused tip-over and against wind-caused relocation and reorientation of the deployed sign by improving the ground-contacting foot of the stabilizers. After extensive review of multiple portable sign systems currently in use by construction companies and departments of transportation, the present inventors have found a number of shortcomings:
a. All existing designs that were reviewed were designed only for use on flat and level surfaces. In fact, every manufacturer that were reviewed by the present inventors stated someplace in their specification and/or operational manuals that their jackstands should only be used on flat and level surfaces. A vast majority of aftermarket additions reviewed which modify the existing footplate were designed to increase the size of the footplate to decrease the weight per square inch placed on the supporting surface and to broaden the footprint so they will not sink into the ground.
b. All reviewed current designed footplates were designed to provide only vertical support without any resistance to horizontal lifting which occurs during tipping of the sign.
c. No footplates were found in the inventors' review which didn't incorporate features that minimized side-to-side friction with the supporting surface.

So, what the present inventors realized after their review is that not only are existing footplate designed to limit side-to-side horizontal friction, the existing footplates are designed intentionally to decrease the horizontal sliding resistance of jackstand supports. Still further, the present inventors recognized that these intentional design limitations are exacerbated by the fact that road shoulders and roadside ditches are crafted to channel the water runoff and they generally have an increasing downward slope in this transition. As such, the present inventors recognized that current jackstand footplates minimalize contact on these sloped surfaces with just one edge of the footplate touching the earth.

The present inventors noticed that one significant mode of failure of deployed roadside signs, whether equipped with removeable transportation subsystems as described in the related invention, or conventional signs with affixed wheels, is lateral movement after they are placed, positioned and “aimed” due to wind hitting the large surface of the sign itself. By lateral, we are referring generally to side-to-side movements, including but not limited to horizontal movement. For example, if the sign is deployed with at least one stabilizer foot resting on a 10 degree downward slope, such as a shoulder or apron of a road, side-to-side movement in a manner parallel to the surface of the shoulder or road will be referred to as “lateral” for the purposes of the present disclosure.

When wind of a certain speed or higher hits the sign surface, enough lateral force is place on the entire sign system that it causes the sign system to move laterally, and sometimes to tip over the sign if the wind is strong enough. As such, there are two wind speed thresholds of interest:
(1) the minimum wind speed which would cause the sign system to move laterally, i.e., to be displaced; and
(2) the minimum wind speed which would cause the sign system to tip over.

With respect to the first wind speed threshold, when a portable sign system of the prior art is blown from its initial position where it was placed by the traffic engineers, several things can happen. First, the displaced unimproved sign may not be pointed or aimed in the correct direction, thereby causing approaching drivers to not be informed of the critical message on the sign. This can lead to wrecks, injuries and deaths. Second, the displaced unimproved sign system may be pushed laterally, i.e., displaced, into the flow of traffic or pathways of nearby construction equipment, potentially causing wrecks, injuries and deaths. Third, the sign system may be displaced into an area where the slope of the ground is downward, causing the sign to tip and tumble into a ditch, creek, underpass, etc. Fourth, if the wind speed is great enough, the unimproved sign may simply tip over at its initial location, thereby negating all benefits of the information, warnings, etc., provided by the sign. As a result of any or all of these, wrecks, and injuries are possible.

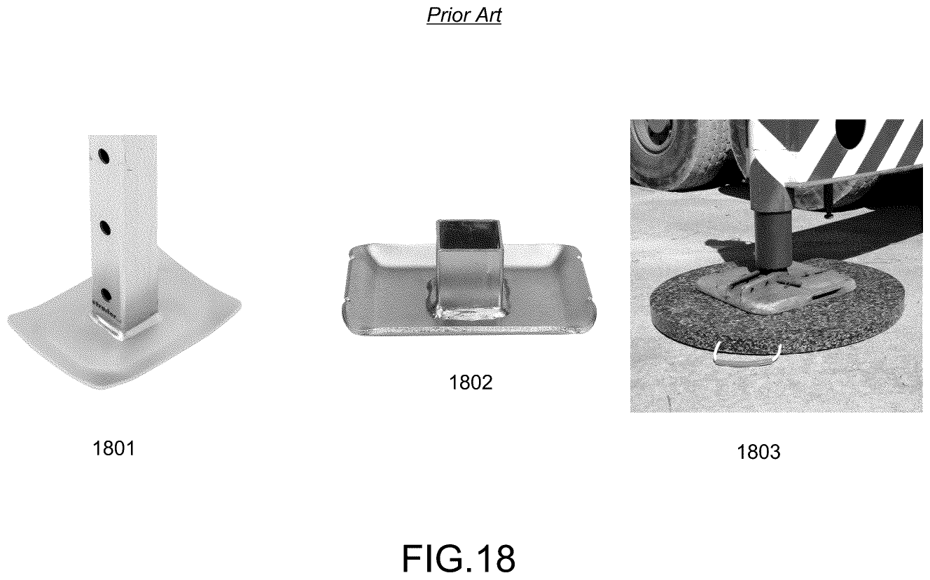

The present inventors examined the structures and designs of components of roadside sign systems available in the market, and discovered that most, if not all, of them use “stock” footplates for their stabilizers, some examples of which are shown in FIG. 18, which include a replacement drop leg with a footplate 1801 available from Etrailer of Wentzville, Missouri, USA; an ultra-tow jack foot base 1802 available from Northern Tool of Burnsville, Minnesota, USA; and a premium outrigger pad 1803 available from TVH UK Ltd. Of Kidderminster, United Kingdom. These devices and their alternatives are so ubiquitous that an ordinarily skilled person in the relevant arts might not even notice the similarities among them.

The present inventors noticed a first aspect of similarity that the feet were all generally metal (probably required for strength), with smooth surfaces on the bottom that contacts the earth, roadway, deck, etc. The present inventors also noticed that many of them had turned-up edges, like skis or skids, and that many of them are actually formed such that their bottom surfaces are concave upwards in shape. These two elements reduce the area of contact between the bottom metal surface of the foot and the top surface of the road, ground, deck, etc., onto which the stabilizer is lowered and engaged. Each of these design aspects of well-known feet, and especially all of them in combination, serve to reduce the amount of friction between the foot and the material onto which the stabilizer is lowered and engaged. The present inventor discovered that this lack of friction contributes significantly to lowering the amount of lateral wind force that a deployed sign can withstand before it begins to move sideways and, eventually, tip over.

In search of existing solutions or remedies, the present inventors found none that solve the actual problem. For example, it is common to see operators of equipment with outrigger-style stabilizers to use lumber, plywood, or specially-designed pads under the stabilizer feet. An ordinarily skilled person in the arts might believe, under casual observation, that these would increase the friction between the stabilizer and the ground surface to help solve these side-to-side (lateral) repositioning due to wind. However, they would be wrong.

For example, the compressible example pad 1803 of FIG. 18 does not actually solve either the lateral movement problem or the tip-over problem. With regard to lateral movement, the pad does not actually attach to the stabilizer foot. So, while the pad may have a high friction coefficient with a surface of concrete or asphalt, the pad still has a low friction coefficient with the stabilizer foot itself. As such, the foot may still slide lateral across the top of the pad, and eventually fall off the pad and engage the roadway or deck directly. Such a pad does not have a high coefficient of friction with any loose top material, such as gravel, dirt, grass, etc. These pads were not really designed for the purpose of preventing lateral movement of the stabilizer foot—they were design to distribute the force placed onto the supporting surface (road, deck, earth, etc.) and to protect that surface from damage by the foot.

So, while stabilizer foot pads may appear to be suitable for preventing lateral movement of a deployed sign, they are not. In fact, given that some of them are compressible, such as recycled rubber material, they may allow a sign that is sitting on top of them to rock and buffet due to wind, leading to possible resonance and eventual damage to the sign and/or toppling of the sign.

For these reasons and due to these discoveries not well known in the arts, the present inventors have designed an improved stabilizer foot described in the following paragraphs and associated drawings of example embodiments.

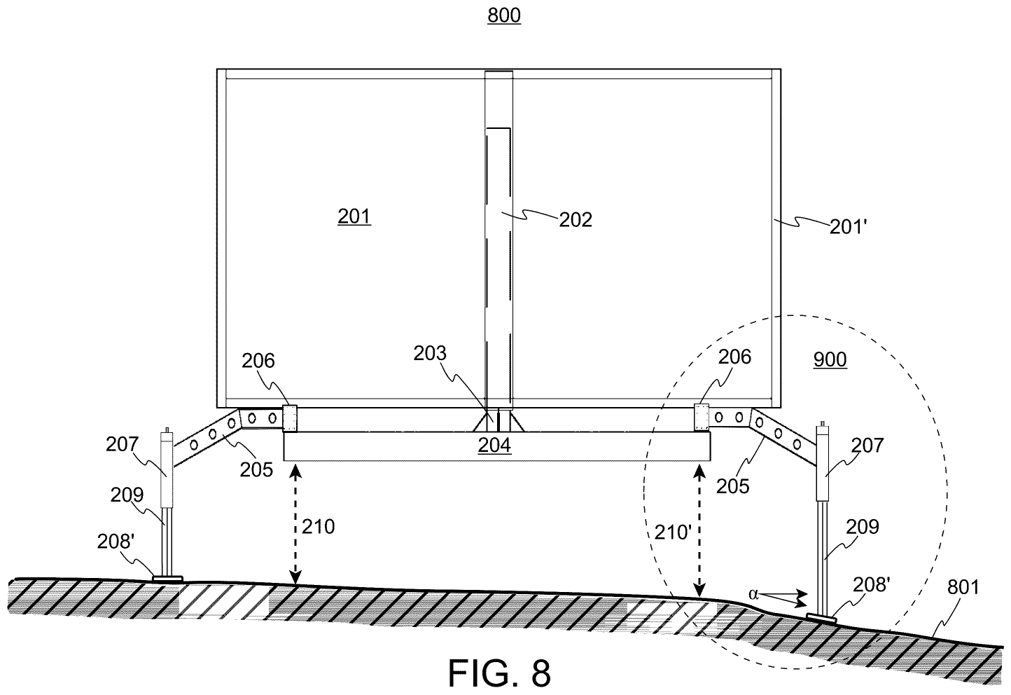

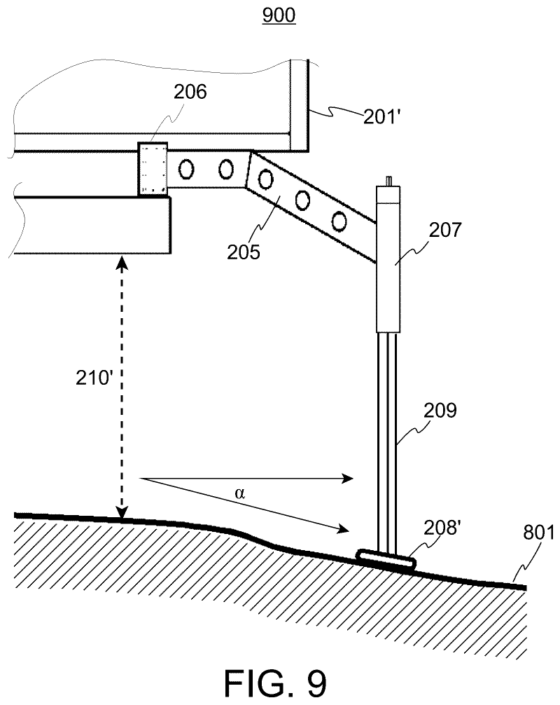

Referring now to FIG. 8, a sign system is shown 800 sitting on a non-level grade 801. For the sign to be level, the heights 210, 210′ at the extreme edges of the sign base 204 are not equal as the grade declines by an angle α (alpha). The improved stabilizer foot 208′ preferably is configured to tilt or rotate to match the angle of the surface that it engages in order to maximize the amount of physical contact between the surface and the foot. FIG. 9 provides a detailed view 900 of how such an improved foot tilts or rotates.

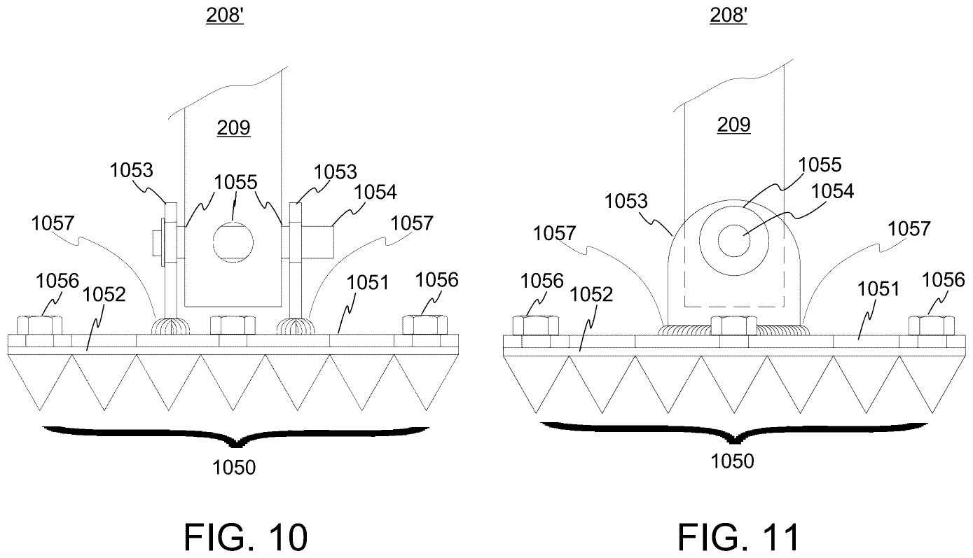

Referring now to FIG. 10, an example embodiment 208′ of an improved according to the present invention is shown from a first side view. A foot plate 1051 is provided with one or more brackets 1053 for attachment to a lower end of a stabilizer leg 209. The one or more brackets have one or more attachment points, such as holes 1055, for affixing the foot plate 1051 to the end of the stabilizer leg 209, such as by with a pin 1054 disposed through holes 1055 to provide a pivoting attachment. A friction plate 1052, such as a plate with teeth 1050, is affixed to the foot plate 1051, such as by one or more bolts, screws, rivets, welds, snaps, etc. 1056. The friction plate has a sufficiently greater coefficient of friction with dirt, gravel, grass, concrete and asphalt than the coefficient of friction of the bottom metal surfaces of conventional jack and stabilizer feet to significantly improve lateral movement rejection at much higher wind speeds.

FIG. 11 shows the same example embodiment of FIG. 10, except from a 90 degree rotation, to provide a better view of the brackets 1053. In this example embodiment, the brackets 1053 are welded using full fillets 1057 to the foot plate 1051. In other embodiments, the bracket may be attached using other convention means, or they may be formed by bending a portion of the foot plate into a position suitable for performing the same pivoting function.

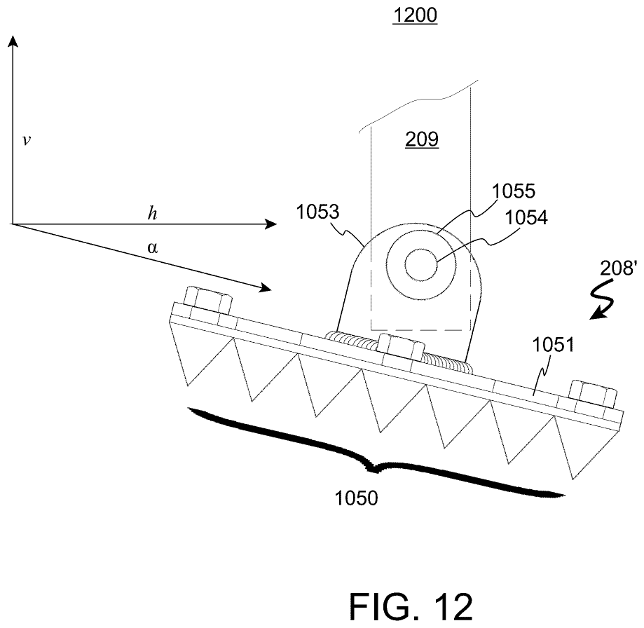

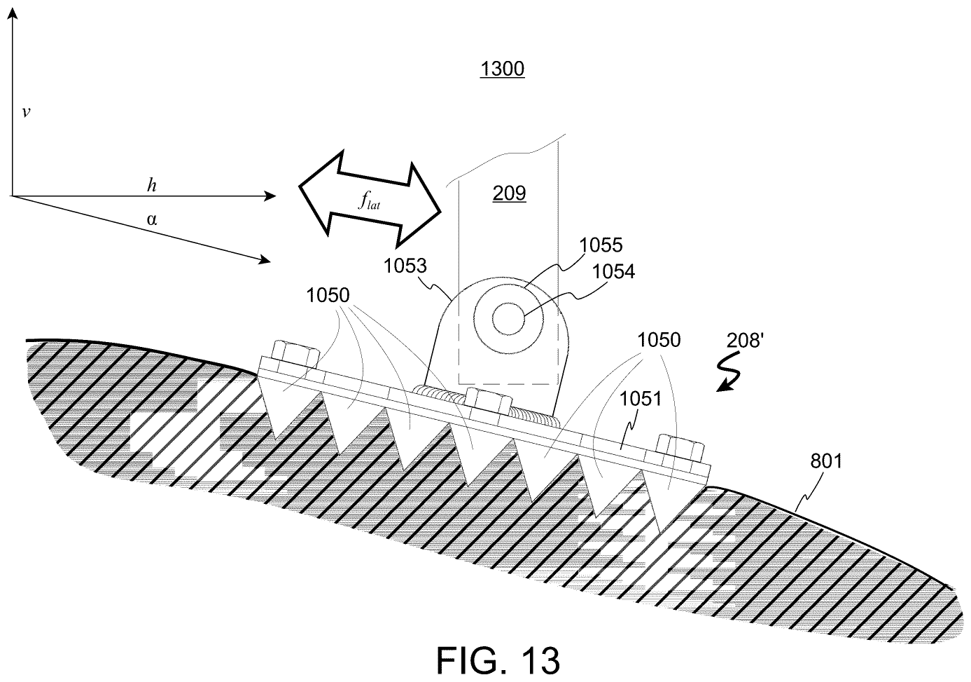

FIG. 12 illustrates how the example embodiment of FIGS. 10 and 11 can pivot around the bracket attachment to an angle α (alpha) above, below or equal to horizontal h. This pivoting action maximizes contact with the ground surface to maximize friction to resist lateral movement.

Returning to FIGS. 10 and 11, and keeping FIG. 12 in mind, one available feature of this example embodiment and other available embodiments is that the extension leg 209 of the stabilizer is provided with a plurality of attachment points, such as sets of through-holes at different rotational positions, so that the improved foot 208′ may be mounted at a plurality of rotational positions to match a greater range of slope contours. If the pivot mechanism is a removeable pin, such as a lynch pin, or even a removeable bolt, the operator may easily remove the pivot mechanism, rotate the foot, and re-install the pivot mechanism to select a better foot position for conforming to the surface which the stabilizer is to engage.

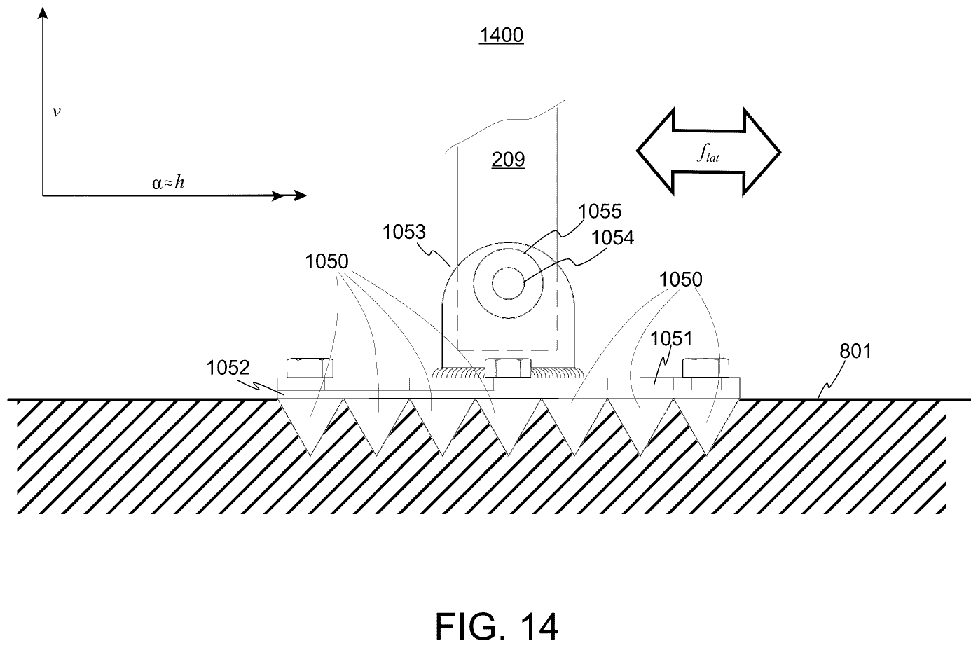

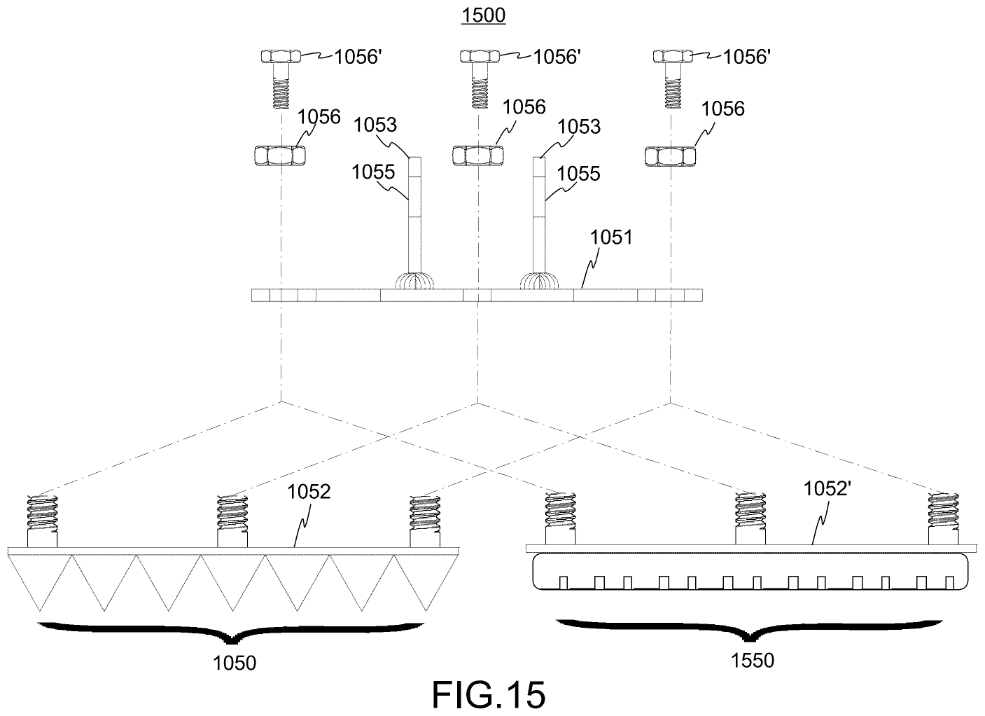

FIG. 14 illustrates how the friction plate 1052 with teeth 1050 can provide a very high degree of lateral friction with the surface 801 when the material under the surface is susceptible to being penetrated by the teeth. Considered individually, this improvement alone greatly increases the resistance of the deployed system from lateral movement. However, not all surfaces are suitable for engagement using teeth, so according to this example embodiment, the improved foot may be supplied with a variety of friction plates, such as shown 1500 in FIG. 15.

In this example embodiment, each friction plate 1050, 1550, is optionally removeably attached, such as by bolts 1056′ or by threaded studs and nuts 1056, for example, such that an operator may easily switch friction plates depending on the type of surface upon which the stabilizer will be engaged. In this second example embodiment of an improved friction plate 1552′ according to the present invention, a high-friction material such as a section of tire tread 1550 is affixed to the friction plate 1052′, thereby giving this friction plate a lateral coefficient of friction similar to that of a vehicle tire. This example embodiment friction plate would be suitable for use on asphalt or concrete where cleats on a footplate would not penetrate into the supporting surface.

FIG. 19 illustrates another example embodiment for an optionally-removeable friction plate 1950 which is configured to be received into a foot holding base 1951 which may be glued 1952 to the surface of a road, walk, shoulder, tarmac, deck, etc. Such glue-down holding bases with removable traffic markers and barriers are well known, so in at least one embodiment, such a friction plate would be configured to engage the glued-down holding to provide maximum lateral movement resistance, while also being quick to release for retrieval of the sign system.

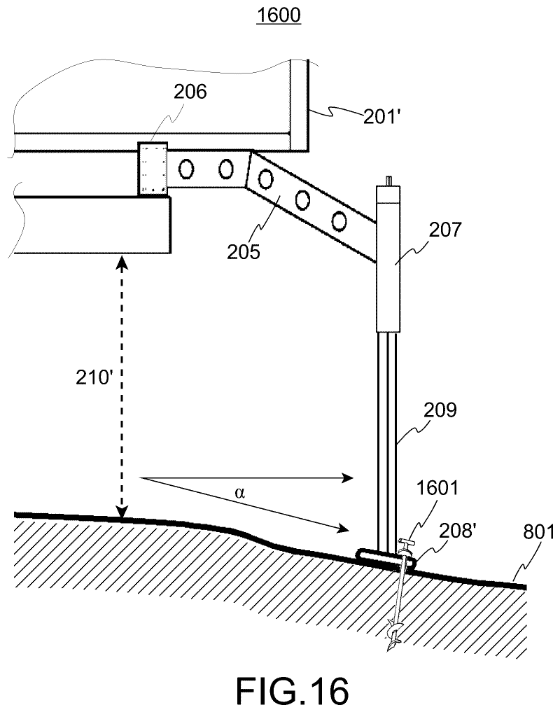

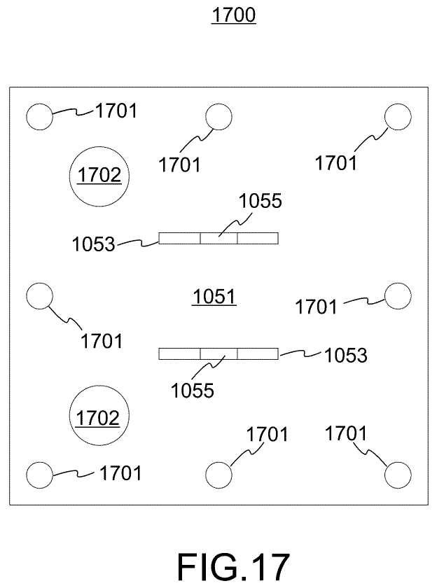

FIG. 17 depicts a top-down view of a foot plate 1700 which not only has several holes 1701 through which a friction plate is attachable, but also has one or more holes 1702 through which an earth anchor may be received. In such an embodiment, even greater resistance to lateral movement and potentially additional resistance to foot lifting (leading to tipping) can be achieved by driving an earth anchor 1601 through the hole 1702 in the improved foot, as shown in FIG. 16.

Vastly Improved Resistance to Tip-over and Lateral (Horizontal) Movement. Through utilization of one or more of these improvements to the feet on the outrigger stabilizers, the maximum speed below which the deployed sign is stable without moving laterally is greatly increased and improved, according to the analysis and prototype testing by the present inventors.

For example, when utilizing the friction plate with teeth but without the added benefit of earth anchors, for a sign of 10 feet wide by 7 feet tall, having a total weight of the deployed sign of about 2900 pounds, the combined benefit of the lowered center of gravity (of the related invention) and significantly increased lateral friction between the footplates of the stabilizers and the roadway or ground, the deployed sign can withstand a wind incident orthogonally onto the surface of the sign (worst case angle of incidence) of 87 mph, which is 25 pounds per square foot of wind pressure on the sign surface. This improvement far exceeds the 62 mph (12.5 pounds per square foot on the sign surface) of the existing portable sign systems on the market. This is a 40% increase in the maximum tolerable wind speed over the existing portable sign systems.

Still further improvement in performance is obtained with the aforementioned earth anchors when the supporting surface is suitable. When the cleated footplates are utilized with earth anchors a 200-300 pound in-ground retention, significant resistance to lifting of the footplates increases the anti-tip-over characteristic of embodiments of the present invention to withstand as much as 100 mph winds incident on the sign surface, which is an 60% improvement over the trailers reviewed by the present inventors.

Conclusion. The corresponding structures, materials, acts, and equivalents of all means or step plus function elements in the claims below are intended to include any structure, material, or act for performing the function in combination with other claimed elements as specifically claimed. The description of the related invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An improved foot for a lift-stabilizer apparatus for a separable and deployable portable sign comprising:
a foot plate;
one or more brackets configured to attach to an end of a vertical extension member of a jack or stabilizer;
a pivoting attachment between the foot plate and the one or more brackets; and
a friction plate affixed to a bottom of the foot plate, wherein the friction plate is provided with a friction component having a coefficient of friction greater than a coefficient of friction of steel on concrete and greater than a coefficient of friction of steel on asphalt, wherein the friction component resists lateral movement of the foot plate relative to a surface on which the foot plate rests.

2. The improved foot as set forth claim 1 wherein the one or more brackets comprise one or more brackets extending vertical upward from the foot plate.

3. The improved foot as set forth claim 1 wherein the pivoting attachment comprises a pin configured to be arranged through one or more holes formed in the end of the vertical extension member of the jack or stabilizer.

4. The improved foot as set forth claim 3 wherein the pin comprises a hand-removeable pin.

5. The improved foot as set forth claim 1 wherein the one or more brackets or the pivoting attachment, or both, cooperation to allow rotation of the improved foot about a vertical axis aligned with the vertical extension member of the jack or stabilizer.

6. The improved foot as set forth claim 1 wherein the friction plate is removeable from the foot plate.

7. The improved foot as set forth claim 1 wherein the friction plate comprises downward-projecting teeth configured to penetrate soft surfaces.

8. The improved foot as set forth claim 1 wherein the friction plate comprises a semi-rigid material configured to engage hard surfaces.

9. The improved foot as set forth claim 1 wherein the semi-rigid material of the friction plate comprises a portion of tire tread.

10. The improved foot as set forth claim 1 wherein the friction plate comprises an attachment configured to be received into, by, or onto a glued-down foot holding base.

11. The improved foot as set forth claim 1 wherein the foot plate further comprises at least one hole, aperture, loop, eyelet or ring configured to receive an earth anchor.
